(19) United States
(12) Patent Application Publication
(10) Pub. No.: US 2006/0116895 A1
(43) Pub. Date: Jun. 1, 2006

(54) Business method for preserving the value of business assets

(75) Inventor: Robert E. Sharp, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Information Technology Multiple Listing Service, Inc.

(21) Appl. No.: 10/999,851

(22) Filed: Nov. 30, 2004

(51) Int. Cl. G06Q 99/00

(52) U.S. Cl. 705/1

(57) ABSTRACT

A business method for preserving the value of business assets, and more particularly, the value of assets that are subject to associated license agreements.

### BACKGROUND OF THE INVENTION

The present invention relates to a business method for preserving the value of business assets, and more particularly, the value of assets that are subject to associated license agreements.

Many businesses use equipment or other assets that are subject to license agreements. For example, a typical business may use computers, computer software, communications equipment, security equipment, and many other types of assets, the continued use of which is licensed. Often, this equipment, such as storage array servers and telephone systems may be quite expensive, and therefore entail a significant percentage of the assets of the owning business.

These associated licenses are typically purchased with the equipment when is equipment is new. These associated licenses can include software, operating systems, right to use, warranty and long term service agreements, etc. Most associated licenses contain restrictions provisions that do not allow the sale and or transfer of these associated licenses to a third party. Many associated licenses can also contain business operations restrictions that can trigger a provision that causes the associated licenses to be come null and void. For example, many associated licenses have restrictions that do not allow the user of the associated licenses to have a change of control, merge or be acquired by another business without the associated licenses becoming null and void. The great majority of all equipment purchased will be sold by the original purchaser to another purchaser. When equipment is sold that is subject to associated licenses that have restrictions limiting or prohibiting their sale and or transfer to a third party the amount that the equipment can be sold for is severely limited. There are many reasons for equipment subject to associated licenses agreements to become available for sale. Here are a few examples: a business may want or need to replace older equipment with newer or different equipment, lenders or venture capital firms may have to repossess equipment because of non payment or default and companies may need to sell recently acquired equipment in order to raise cash to continue operations, companies with such equipment may be merged with an other company or acquired who may not have a need for the specific equipment etc

Over time, a business will want to replace worn equipment, upgrade to a newer model of equipment, change brands, etc. In that instance, it is often desirable for a business to sell its old equipment to recoup some of the cost of purchasing new equipment. Unfortunately, many of the licenses that are associated with the equipment to be sold include non-transferability provisions such that the purchaser of the equipment would either be unable to use the equipment itself, i.e. the hardware, or would be unable to use the software associated with the equipment without the purchaser obtaining a new license at considerable expense. The inability of an owner of this business equipment to transfer its associated license thus considerably degrades the resale value of the equipment, typically by at least 50%. Or in the case of a change of control, merger or acquisition occurrence which has been specifically prohibited by the associated licenses and causes the associated licenses to become null and void, where the continued use of the associated licenses may have severe legal or financial consequences.

The minimal resale value of such equipment has a significant deleterious effect on industry. First, the significant expense of purchasing a new license for used equipment drives up the cost of entry into a market or business. Second, the lack of a significant resale value of old equipment acts as a disincentive to upgrade to new, more efficient equipment. Third, the lack of significant resale value for technology assets makes technology businesses vulnerable to economic downturns due to the relatively small amount of cash that can be raised, if needed, by selling those assets—i.e. technology businesses have a tendency to be undercapitalized. This often makes it difficult to persuade venture capitalists or lenders to invest in technology businesses because their investment will tend to be undersecured. Together, these adverse impacts act to drive up the costs of the goods and services provided by the users of such equipment.

What is desired, therefore, is a system that enhances the resale value of equipment or other assets that are subject to license agreements having transferability restrictions and/or business operations restrictions and/or business operation restrictions.

### SUMMARY OF THE INVENTION

A first embodiment of the present invention is a method comprising the steps of forming a legally recognized business entity, acquiring for said business entity at least one asset having an associated license agreement with a transferability restriction, and transferring said business entity to a purchaser who wishes to acquire said at least one asset. Preferably, after the acquisition of the asset or assets by the business entity, the net worth of said business entity has total assets substantially equivalent to the whole of the assets it acquires.

A second embodiment of the present invention is a method comprising the steps of forming a plurality of legally recognized business entities, acquiring for each of the business entities at least one asset having one or more associated license agreements each with a transferability restriction, and transferring a selective one or more of the business entities to a purchaser who wishes to acquire those assets. Preferably, after the acquisition of the assets by the respective business entities, the net worth of each business entity has total assets substantially equivalent to the whole of the assets it acquires.

A third embodiment of the present invention is a method for maximizing the resale value of a customer's licensed assets in which a request is received from a customer for the purchase of assets, each asset having at least one associated license agreement with a transferability restriction. The requested assets are categorized into one or more asset groups, each asset group having assets with associated one or more license agreements not associated with the assets of any other asset group. A number of legally recognized business entities equal to the number of said asset groups are formed and the assets of a respective one of the asset groups are acquired for each said business entity. The business entities are then transferred to the customer.

A fourth embodiment of the present invention is a business method for preserving the value of assets having associated one or more license agreements. The method may comprise the steps of forming a corporation, associating with the corporation one or more of the license agreements, and acquiring on behalf of said corporation at least one asset associated with the one or more license agreements associated with said corporation.

A fifth embodiment of the present invention is a business method for maximizing the resale value of a customer's licensed assets comprising the steps of initially forming a legally recognized business entity, subsequently acquiring for said initial business entity a wholly owned legally recognized business entity, acquiring for said wholly owned business entity at least one asset having at least one associated license agreement with at least one transferability restriction and or business operations restriction, and selling said initial business entity to a purchaser who wishes to acquire said at least one asset of the said subsequent wholly owned business entity. Preferably, after the acquisition of the subsequent business entity, the net worth of the said initial business entity has total assets substantially equal to the whole of the said subsequent business entity, which preferably has total assets substantially equivalent to the whole of the assets it acquires.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 shows a diagram illustrating one embodiment of the present invention.

FIG. 2 shows a diagram illustrating a second embodiment of the present invention

FIG. 3 shows a diagram illustrating a third embodiment of the present invention

FIG. 4 shows a diagram illustrating a fourth embodiment of the present invention

### DETAILED DESCRIPTION OF PREFERRED EMBODIMENTS

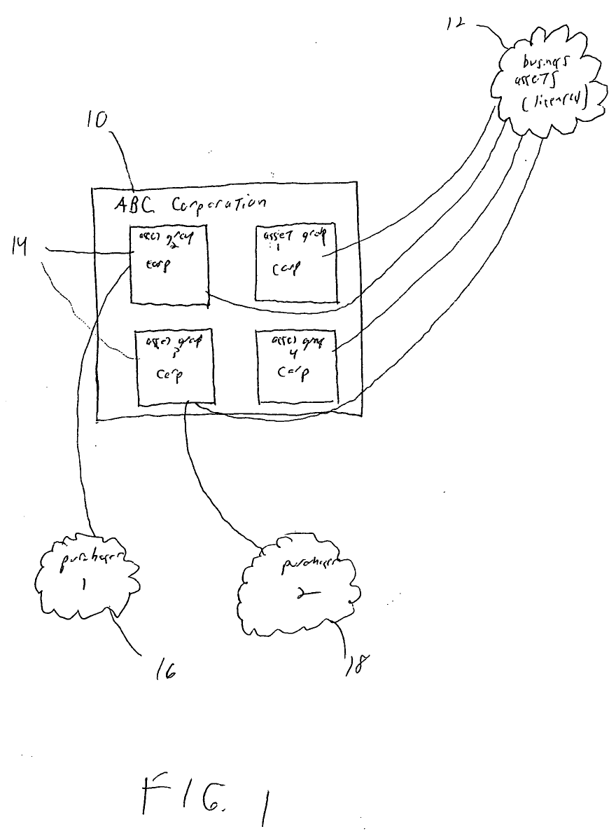

FIG. 1 shows a business 10 structured in accordance with the method of the present invention. Though FIG. 1 illustrates a corporation 10, any other type of business may employ the disclosed method, such as a partnership, a limited liability partnership, or an individual. The business 10 may own, control, or use a plurality of business assets 12 subject to one or more license agreements. Though the business assets 12 will typically be technology assets such as computers, servers, software, etc., the assets 12 may be any other type that has one or more associated license agreements. Such license agreements are usually associated with the use of plural items or instances of a single type of business asset. For example, a license agreement may be associated with the use of a specified number of servers, or telephones having proprietary software, etc. Typically a single license agreement will cover both the use of the hardware and associated software, but sometimes separate license agreements will be crafted for the use of the hardware and the software, particularly if different vendors are involved.

As things currently exist, any of these license agreements that have provisions prohibiting or otherwise restricting the transfer of the licenses would significantly degrade the resale value of the equipment covered by the license agreements. The assets substantially equivalent to the whole of the licensed assets 12 it respectively acquires.

Preferably, the value of the licensed assets 12 of the corporation 14 will exceed eighty percent of the total value of the corporation 10. More preferably, the value of the licensed assets 12 of the corporation 14 will exceed ninety percent of the total value of the corporation 14.

In a simple embodiment, the business 10 may include only a single corporation 14 that has acquired all of its licensed assets 12. In some instances, and particularly if the business 10 is using many types of assets subject to a number of license agreements, it may be desirable to form a plurality of corporations 14 such that the assets 12 may be divided among the corporations 14 in a manner that achieves the greatest flexibility in selling selected portions of the assets 12. Preferably, each of the corporations 14 is assigned assets associated with either a single license agreement or a series of related license agreements such that the license agreement or agreements associated with one corporation 14 are not associated with the assets of any other corporation 14. In this manner, the business 10 may sell a selected portion of its assets 12 by selling a selected one or more of the corporations 14.

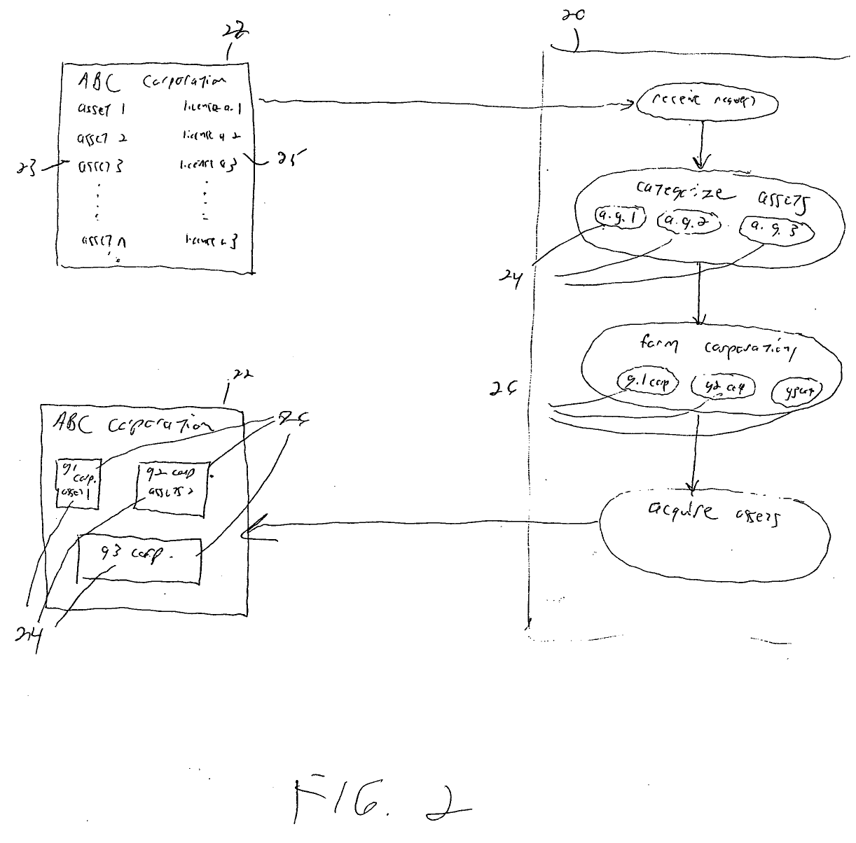

Referring to FIG. 2, a vendor business 20 may provide asset structuring services to assist customers in structuring their businesses to maximize the resale value of assets subject to license agreements. In this embodiment, the vendor business 20 may receive a request from a customer business 22 to acquire specified assets 23 subject to one or more license agreements 25. Upon receipt of this request, the vendor business 20 may preferably categorize the assets 23 into asset groups 24 that each have an associated license agreement or set of related license agreements that together license the use of assets within their respective asset groups, but not within the asset groups associated with other license agreements.

Once the assets 23 have been categorized into a number of asset groups, the vendor business 20 forms a number of corporations or other business entities 26. The respective corporations 26 then acquire the assets of a selected one of the asset groups 24, along with their associated license agreements. The corporations 26 are then transferred to the purchaser corporation 22.

In an alternate embodiment, the vendor business 20 may receive a request from a customer business 22 to acquire specified assets 23 subject to one or more license agreements 25. Upon receipt of this request, the vendor business 20 may preferably categorize the assets 23 into asset groups 24 that each have an associated license agreement or set of related license agreements that together license the use of assets within their respective asset groups, but not within the asset groups associated with other license agreements.

Once the assets 23 have been categorized into a number of asset groups, the vendor business 20 forms a number of corporations or other business entities 26 on behalf of the customer business 22. The respective corporations 26 then acquire the assets of a selected one of the asset groups 24, along with their associated license agreements.

In another embodiment, a business 10 may form a corporation 14 and acquire licensed assets 12 on behalf of the corporation 14. The business 10 then leases to a customer the corporation 14 along with its licensed assets. When the lease expires or is otherwise terminated, the business 10 may lease the corporation 14 to another customer.

(DELETED here but moved to paragraph 0028.13) The terms and expressions that have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims that follow.

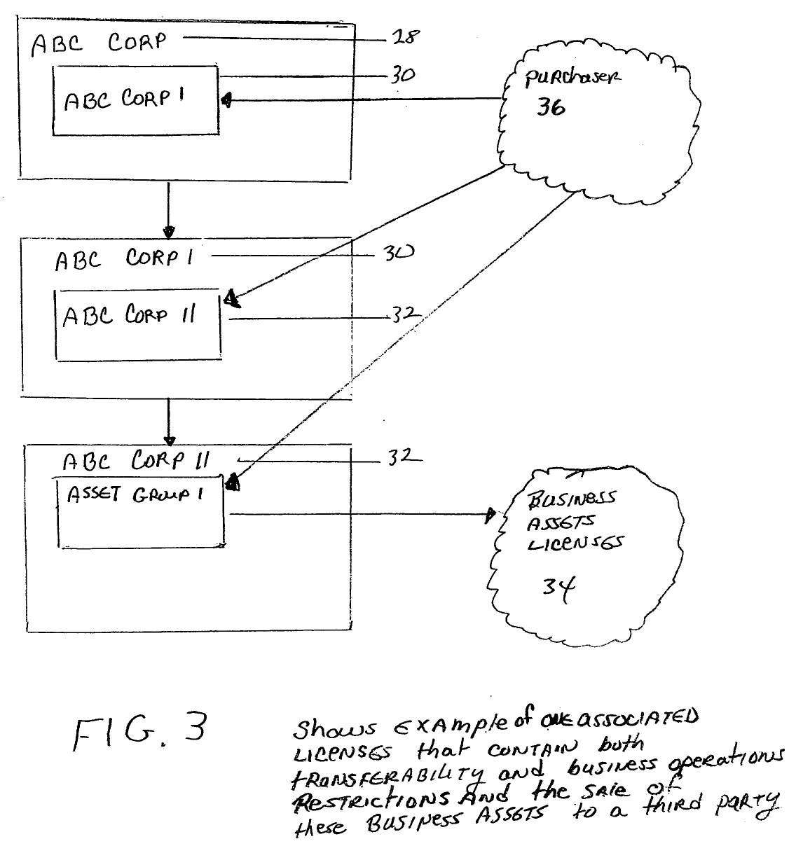

Through FIG. 3 shows a business 28 structured in accordance with the method of the present invention. FIG. 3 illustrates a corporation 28; any other type of business may employ the disclosed method, such as a partnership, a limited liability partnership, or an individual. The business 28 acquires 100% of business 30, Though FIG. 3 illustrates a corporation 30, any other type of business may employ the disclosed method, such as a partnership, a limited liability partnership, or an individual. The business 30 acquires 100% of business 32. Though FIG. 3 illustrates a corporation 32, any other type of business may employ the disclosed method, such as a partnership, a limited liability partnership, or an individual. The business 32 acquires business assets 34 that are subject to associated licenses that have a both transferability prohibitions as well a business operation restriction on the user. For example, such business operation restrictions may limit or outright prohibit the user of the associated business license to have a change in company control, be merged with or acquired by another business entity. Any such occurrence may cause the associated licenses to become null and void. There may be other business operations restrictions which may impose other restrictions on the user as well.

The business 28 may own control, or use a plurality of business assets 34 subject to one or more license agreements. Though the business assets 34 will typically be technology assets such as computers, servers, software, etc., the assets 34 may be any other type that has one or more associated license agreements. Such license agreements are usually associated with the use of plural items or instances of a single type of business asset. For example, a license agreement may be associated with the use of a specified number of servers, or telephones having proprietary software, etc. Typically a single license agreement will cover both the use of the hardware and associated software, but sometimes separate license agreements will be crafted for the use of the hardware and the software, particularly if different vendors are involved.

As things currently exist, any of these license agreements that have both provisions prohibiting or otherwise restricting both the transfer of the licenses and or business operation restrictions would significantly degrade the resale value of the equipment covered by the license agreements. The business 28, however, as disclosed in FIG. 3 has formed one or more corporations 30, in which business 30 has formed one or more corporations 32 which acquired the licensed assets 34 for the one or more corporations 32. When it is desired to sell the licensed assets 34 which have both transferability and/or business operations restrictions to a purchaser 36, the business 28 simply sells the corporation 30. By selling business 30 which owns 100% of business 32 which owns business assets 34 to purchaser 36, business 30 and 32 and business assets 34 are also sold to purchaser 36.

A business 28 structured as shown in FIG. 3 has the advantage of being able to realize a greater resale value of its licensed assets 34 than such existing businesses. Because the licenses 34 are owned or leased by the corporations 32, which is wholly owned by corporations 30 which is owned by corporation 28 the licenses 34 are unaffected by the transfer of the corporations 32 and therefore the purchaser 36 may use the purchased assets 34 without acquiring a new license. For that reason, a purchaser 36 would be willing to pay a significantly higher price for these assets than if the purchaser would have to acquire a new license to use the purchased assets.

Though FIG. 3 shows corporations 28 acquiring corporations 30 with corporations 30 acquiring corporations 32 which acquires the licensed assets 34, other business structures or legal entities may also be employed, such as limited liability partnerships, etc. Furthermore, the corporations 30 and 32 may be formed wither prior to the acquisition of the respective licensed assets 34 or substantially concurrently with the acquisition of the licensed assets.

In some embodiments of the present invention, to achieve the greatest flexibility in selling dated licensed assets 34, each of the corporations 30 and 32 will preferably have total assets substantially equivalent to the whole of the licensed assets 34 it respectively acquires. That is to say, if a corporation 30 or 32 were, in addition to the licensed assets 34 respectively acquired by the corporation 32, to also acquire an asset substantially unrelated to the operation of the business 28, such that the sale of that unrelated asset along with the sale of the licensed assets 34 held by the corporation 30 or 32 would either not significantly alter the selling value of the corporation 30 or 32 compared to its selling value without the unrelated asset or not significantly affect the continued operation of the business 28 using replacement assets for those sold with the corporation 30 or 32, excepting the unrelated asset, the corporation 30 or 32 would still have total assets substantially equivalent to the whole of the licensed assets 34 it respectively acquires.

Preferably, the value of the licensed assets 34 of the corporation 32 will exceed eighty percent of the total value of the corporation 30. More preferably, the value of the licensed assets 34 of the corporation 32 will exceed ninety percent of the total value of the corporation 30.

In a simple embodiment, the business 28 may include only one corporation 30 which has acquired corporation 32 and that corporation 32 has acquired all of its licensed assets 34.

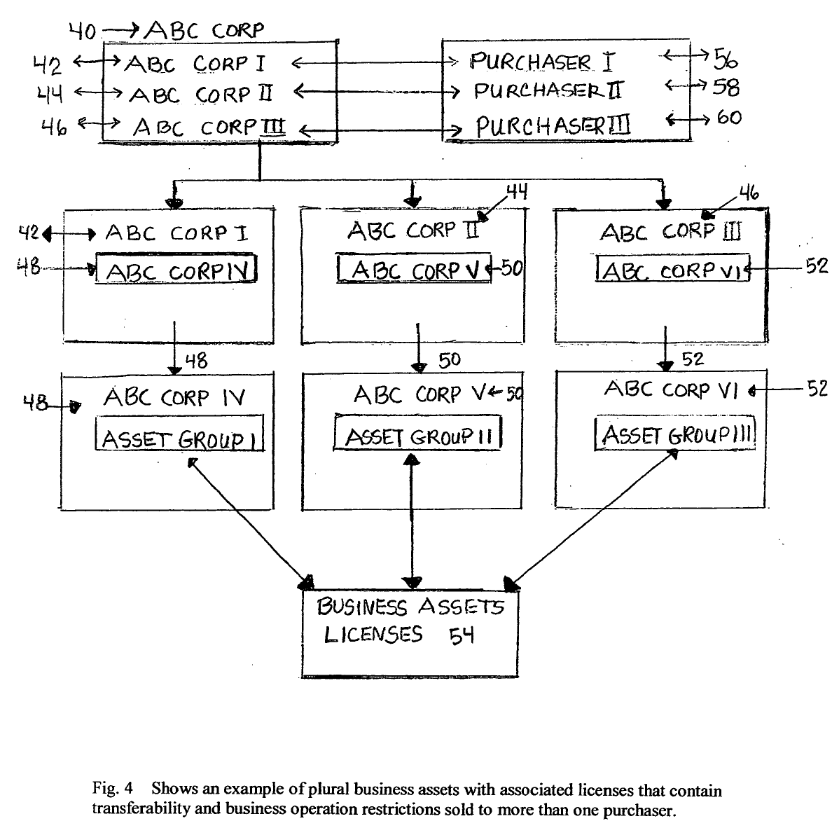

Through FIG. 4 shows in some instances, and particularly if the business 40 is using many types of assets subject to a number of license agreements, it may be desirable to form a corporations 40 through FIG. 4 which will form a plurality of corporations 42, 44, 46 which will form a plurality of corporations 48, 50, 52 such that the assets 54 may be divided among the corporations 48, 50, 52 in a manner that achieves the greatest flexibility in selling selected portions of the assets 54. Preferably, each of the corporations 42, 44, 46 acquires corporations 48, 50, 52 which are assigned assets associated with either a single license agreement or a series of related license agreements such that the license agreement or agreements associated with one corporation 48, 50, 52 are not associated with the assets of any other corporation 48, 50, 52. In this manner, the business 40 may sell a selected portion of its assets 54 by selling a selected one or more of the corporations 42, 44, 46 which own each own 100% of one of corporations 48, 50, 53

As things currently exist, any of these license agreements that have both provisions prohibiting or otherwise restricting the transfer of the licenses and or business operations restrictions licenses would significantly degrade the resale value of the equipment covered by the license agreements. The business 40, however, as disclosed in FIG. 4 has formed one or more corporations 42, 44, 46 which each acquires one corporation 48, 50, 52 which each corporation has acquired the plurality licensed assets 54 for the one or more corporations 48, 50, 52. When it is desired to sell the plurality licensed assets 54 to a specific purchasers 56, 58 or 60, the business 40 simply sells the corporation 42, 44 or 46 which owns 100% of corporations 48, 50, 52 which owns the acquired licenses assets 54 to the specific purchaser 56, 58, 60

A business 40 structured as shown in FIG. 3 has the advantage of being able to realize a greater resale value of its licensed assets 54 than such existing businesses. Because the licenses 54 are owned and or leased by the corporations 48, 50 or 52, the licenses 54 are unaffected by the transfer of the corporations 42, 44, 46 and therefore the purchaser 56, 58 or 60 may use the purchased assets 54 without acquiring a new license. For that reason, a purchaser 56, 58, 60 would be willing to pay a significantly higher price for these assets than if the purchaser would have to acquire a new license to use the purchased assets.

A business 40 structured as shown in FIG. 3 has the advantage of being merged, acquired or have a change of control without having the associated licenses 54 of corporations 48, 50, 54 being null and void if the associated licenses 54 have such business operation restrictions. The ownership of corporations 48, 50, 52 remains corporation 42, 44, 48 and therefore so change of ownership have taken place in the case of a change of control, merger or acquisition of corporation 40.

The terms and expressions that have been employed in the forgoing specification are used therein as terms of description and not of limitation, and there is no intention in the use of such terms and expressions of excluding equivalence of the features shown and described or portions thereof it being recognized that the scope of the invention is defined and limited only by the claims that follow.

1. A business method for maximizing the resale value of licensed assets, said method comprising the steps of:
(a) forming a legally recognized business entity;
(b) acquiring for said business entity at least one asset having an associated license agreement with a transferability restriction, where after said acquisition by said business entity, said business entity has total assets substantially equivalent to the whole of the said at least one asset it acquires; and
(c) selling said business entity to a purchaser who wishes to acquire said at least one asset.

2. The method of claim 1 wherein said business entity is a corporation.

3. The method of claim 1 where said business entity is formed prior to said acquisition of said at least one asset.

4. The method of claim 1 where said business entity if formed substantially concurrently with said acquisition of said at least one asset.

5. The method of claim 1 where said at least one asset comprises technology equipment.

6. The method of claim 5 where the use of said technology equipment is subject to said license agreement.

7. The method of claim 5 where said technology equipment has associated software subject to said license agreement.

8. The method of claim 1 where said transferability restriction prohibits the transfer of said license.

9. The method of claim 1 where the at least one asset acquired for said business entity is subject to a single license agreement.

10. The method of claim 1 where said at least one asset acquired for said business entity has plural associated license agreements.

11. A business method for maximizing the resale value of licensed assets, said method comprising the steps of:
(a) forming a plurality of legally recognized business entities;
(b) acquiring for each said business entities at least one asset having one or more associated license agreements each with a transferability restriction, where after said acquisition by said respective business entities, each said business entity has total assets substantially equivalent to the whole of the said at least one asset it respectively acquires; and
(c) selling a selective one or more of said business entities to a purchaser who wishes to acquire the assets of said selective one or more of said business entities.

12. The method of claim 11 wherein said respective business entities are corporations.

13. The method of claim 11 where said business entities are formed prior to said acquisition of said respective at least one asset.

14. The method of claim 11 where said business entities are formed substantially concurrently with said acquisition of said at least one asset.

15. The method of claim 11 where said at least one asset comprises technology equipment.

16. The method of claim 15 where the use of said technology equipment is subject to a respective said one or more associated license agreements.

17. The method of claim 15 where said technology equipment has associated software subject to a respective said one or more license agreements.

18. The method of claim 11 where said transferability restriction prohibits the transfer of said one or more associated license agreements.

19. The method of claim 11 where each respective said business entity acquires assets subject to a single license agreement.

20. The method of claim 11 where none of the said one or more license agreements associated with each particular one of said at least one business entity is associated with assets acquired by another said at least one business entity.

21. A business method for maximizing the resale value of a customer's licensed assets, said method comprising the steps of:
(a) receiving a request from a customer for the purchase of at least one asset having an associated license agreement with a transferability restriction;
(b) forming a legally recognized business entity;
(c) acquiring for said business entity said at least one asset, where after said acquisition by said business entity, said business entity has total assets substantially equivalent to the whole of the said at least one asset it acquires; and
(d) transferring said business entity to said customer.

22. The method of claim 21 wherein said business entity is a corporation.

23. The method of claim 21 where said business entity is transferred to said customer within 90 days following said receipt of said request.

24. The method of claim 21 where said business entity is transferred to said customer within 30 days of receipt of said request.

25. The method of claim 21 where said at least one asset comprises technology equipment.

26. The method of claim 25 where the use of said technology equipment is subject to said license agreement.

27. The method of claim 25 where said technology equipment has associated software subject to said license agreement.

28. The method of claim 21 where said transferability restriction prohibits the transfer of said license.

29. The method of claim 21 where the at least one asset acquired for said business entity is subject to a single license agreement.

30. The method of claim 21 where said at least one asset acquired for said business entity has plural associated license agreements.

31. A business method for maximizing the resale value of a customer's licensed assets, said method comprising the steps of:
(a) receiving a request from a customer for the purchase of assets, each said asset having at least one associated license agreement with a transferability restriction;
(b) categorizing said requested assets into one or more asset groups, each said asset group having assets with associated one or more license agreements not associated with the assets of any other said asset group;
(c) forming a number of legally recognized business entities equal to the number of said asset groups
(d) acquiring for each said business entity the assets of a selected one of said of said asset groups; and
(e) transferring said business entities to said customer.

32. The method of claim 31 wherein each said business entity has total assets substantially equivalent to the whole of the assets in its respective asset group.

33. The method of claim 31 where said business entity is transferred to said customer within 90 days following said receipt of said request.

34. The method of claim 31 where said business entity is transferred to said customer within 30 days of receipt of said request.

35. The method of claim 31 where said at least one asset comprises technology equipment.

36. The method of claim 35 where the use of said technology equipment is subject to said license agreement.

37. The method of claim 35 where said technology equipment has associated software subject to said license agreement.

38. The method of claim 31 where said transferability restriction prohibits the transfer of said license.

39. The method of claim 31 where the at least one asset acquired for said business entity is subject to a single license agreement.

40. The method of claim 31 where said at least one asset acquired for said business entity has plural associated license agreements.

41. A business method for preserving the value of assets having associated one or more license agreements, said method comprising the steps of:
(a) forming a corporation;
(b) associating with said corporation one or more of said license agreements; and
(c) Acquiring on behalf of said corporation at least one asset associated with the one or more of said license agreements associated with said corporation.

42. The method of claim 41 including the step of forming plural said corporations.

43. The method of claim 42 where each said corporation has associated license agreements that are not associated with any other said corporation

44. The method of claim 41 where the value of said corporation is substantially equivalent to the value of said at least one asset it acquires

45. Deleted-The method of claim 41 where the value of said at least one asset comprises at least 80% of the value of said corporation.

46. A business method for maximizing the resale value of licensed assets, said method comprising the steps of:
(a) forming initially at least one legally recognized business entity
(b) the initial corporation acquires 100% of at least one subsequent business entity
(c) acquiring for said subsequent business entity at least one asset having an associated license agreement with a transferability and/or business operation restriction, where after said acquisition by said subsequent business entity, said initial business entity has total assets substantially equivalent to the whole of the said at least the said subsequent business entity it acquires, and said subsequent business entity has total assets substantially equivalent to the whole of the said at least one asset it acquires; and
(d) Selling said initial business entity to a purchaser who wishes to acquire said at least one asset from the said subsequent business entity.

47. The method of claim 46 wherein said business entity is a corporation.

48. The method of claim 46 where said business entity is formed prior to said subsequent business entity acquisition

49. The method of claim 46 where said subsequent business entity is formed prior to acquiring of said at least one asset.

50. The method of claim 46 where said subsequent business entity if formed substantially concurrently with said acquisition of said at least one asset.

51. The method of claim 46 where said at least one asset comprises technology equipment.

52. The method of claim 46 where the use of said technology equipment is subject to said license agreement.

53. The method of claim 46 where said technology equipment has associated software subject to said license agreement.

54. The method of claim 46 where said transferability restriction prohibits the transfer of said license.

55. The method of claim 46 where said business operation restrictions limit and or prohibit the transfer of said license

56. The method of claim 46 where the at least one asset acquired for said subsequent business entity is subject to a single license agreement.

57. The method of claim 46 where said at least one asset acquired for subsequent said business entity has plural associated license agreements.
